(19) United States
(12) Patent Application Publication
(10) Pub. No.: US 2025/0085986 A1
(43) Pub. Date: Mar. 13, 2025

(54) METHOD OF RECONFIGURING A USER INTERFACE, AND SYSTEMS AND DEVICES IMPLEMENTING THE SAME

(71) Applicant: GRANDPAD, INC., Hopkins, MN (US)

(72) Inventors: Scott Lien, Hopkins, MN (US); Isaac Lien, Hopkins, MN (US)

(21) Appl. No.: 18/808,807

(22) Filed: Aug. 19, 2024

Related U.S. Application Data
(60) Provisional application No. 63/582,017, filed on Sep. 12, 2023.

(51) Int. Cl. G06F 9/451; G06F 40/40

(52) U.S. Cl. CPC G06F 9/451; G06F 40/40

(57) ABSTRACT

One aspect of the invention provides a method comprising the steps of: (a) establishing a telecommunication connection with a remote device; (b) generating a prompt to a user of the remote device; (c) receiving data from the user in response to the generated prompt; (d) supplementing the data from the user with information from a user database, the information from the user database including one or more selected from the group consisting of: age, geographical location, medical conditions, audio-processing conditions, visual-processing conditions, cognitive decline, and personal interests; (e) providing the supplemented data to a large language model (LLM); (f) determining a desired response to the provided data based at least in part on the large language model (LLM); and (g) transmitting the desired response to the user.

### CROSS-REFERENCE TO RELATED APPLICATION

This application claims the benefit of priority under 35 U.S.C. § 119(e) to U.S. Provisional Patent Application Ser. No. 63/582,017, filed Sep. 12, 2023. The entire content of this application is hereby incorporated by reference herein.

### BACKGROUND OF THE INVENTION

Presently, telemedicine is used widely by people of all ages. In addition to telemedicine, personal electronic devices like tablet computers may be useful in providing information, telecommunication, and entertainment to people. However, known systems and methods of using personal electronic devices do not adequately address issues posed to certain users, such as elderly people or people with disabilities.

### SUMMARY OF THE INVENTION

One aspect of the invention provides a method comprising the steps of: (a) establishing a telecommunication connection with a remote device; (b) generating a prompt to a user of the remote device; (c) receiving data from the user in response to the generated prompt; (d) supplementing the data from the user with information from a user database, the information from the user database including one or more selected from the group consisting of: age, geographical location, medical conditions, audio-processing conditions, visual-processing conditions, cognitive decline, and personal interests; (e) providing the supplemented data to a large language model (LLM); (f) determining a desired response to the provided data based at least in part on the large language model (LLM); and (g) transmitting the desired response to the user.

This aspect of the invention can have a variety of embodiments. The method can further include: (h) training the LLM based at least in part on the received data from the user. Step (b) can include displaying a visual direction for the subject. The method can further include: (i) modifying a graphical user interface based on one or more of an audio capability of the user, a visual capability of the user, and an audio-visual capability of the user. The telecommunication connection can include one or more of a video channel and an audio channel. The prompt can be automatically provided in response to a detected concern. Steps (b) and (g) can include using a chatbot.

The method can be implemented using a device selected from the group consisting of: a smartphone, a tablet computer, a laptop computer, and a general purpose computing device. The remote device can be selected from the group consisting of: another smartphone, another tablet computer, another laptop computer, and another general purpose computing device.

The method can be implemented using a tablet computer.

Another aspect of the invention provides a device used to implement the method as described herein. The device includes: a graphical user display; and a processor, the processor programmed to implement the method as described herein.

This aspect of the invention can have a variety of embodiments. The device can further include one or more selected from the group consisting of: a communication interface, a microphone, a memory device, and a storage device. The graphical user display can be configured to display a graphical user interface, the graphical user interface being configured to minimize the input from the user.

Another aspect of the invention provides a system used in connection with the methods as described herein. The system includes: a device including: a graphical user display; a camera configured to capture the video stream; and a processor, the processor configured to implement the methods as described herein; and another device, the another device being selected from the group consisting of: a smartphone, a tablet computer, a laptop computer, and a general purpose computing device.

### BRIEF DESCRIPTION OF THE DRAWINGS

For a fuller understanding of the nature and desired objects of the present invention, reference is made to the following detailed description taken in conjunction with the accompanying drawing figures wherein like reference characters denote corresponding parts throughout the several views.

FIG. 1 depicts a network diagram, in accordance with an embodiment of the present disclosure.

FIG. 2 depicts a digital assistant, in accordance with an embodiment of the present disclosure.

FIG. 3 depicts a flow diagram of a method of reconfiguring a user interface, in accordance with an embodiment of the present disclosure.

FIG. 4 depicts a block diagram schematic of a method of reconfiguring a user interface, in accordance with an embodiment of the present disclosure.

### DEFINITIONS

The instant invention is most clearly understood with reference to the following definitions.

As used herein, the singular form “a,” “an,” and “the” include plural references unless the context clearly dictates otherwise.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

As used in the specification and claims, the terms “comprises,” “comprising,” “containing,” “having,” and the like can have the meaning ascribed to them in U.S. patent law and can mean “includes,” “including,” and the like.

Unless specifically stated or obvious from context, the term “or,” as used herein, is understood to be inclusive.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 (as well as fractions thereof unless the context clearly dictates otherwise).

As used herein, “suspension” or “suspending” means pausing, stopping, or temporarily terminating.

### DETAILED DESCRIPTION

The present disclosure provides systems, devices, and methods of reconfiguring a user interface (e.g., of an electronic device). Certain embodiments of the present disclosure provide a method to provide user-tailored information to a user (e.g., an elderly tablet user) in connection with an artificial neural network (ANN) and/or a large language model (LLM). In one exemplary embodiment, the present disclosure provides a method of reconfiguring a user interface, including the steps of: a) establishing a telecommunication connection with a remote device; b) generating a prompt to a user of the remote device; c) receiving data from the user in response to the generated prompt; d) supplementing the data from the user with information from a user database, the information from the user database including one or more selected from the group consisting of: age, geographical location, medical conditions, audio-processing conditions, visual-processing conditions, cognitive decline, and personal interests; c) providing the supplemented data to a large language model (LLM); f) determining a desired response to the provided data based at least in part on the LLM; and g) transmitting the desired response to the user.

Large Language Models (LLMs) and Artificial Intelligence (AI) can be used in connection with provided user-tailored information to a user that can augment and enhance a user experience. LLM- and/or AI-modified user prompts can boost efficiency of a user. In certain embodiments, a customer care unit can be used to provide improved information to an LLM and/or AI powered server (e.g., server 124).

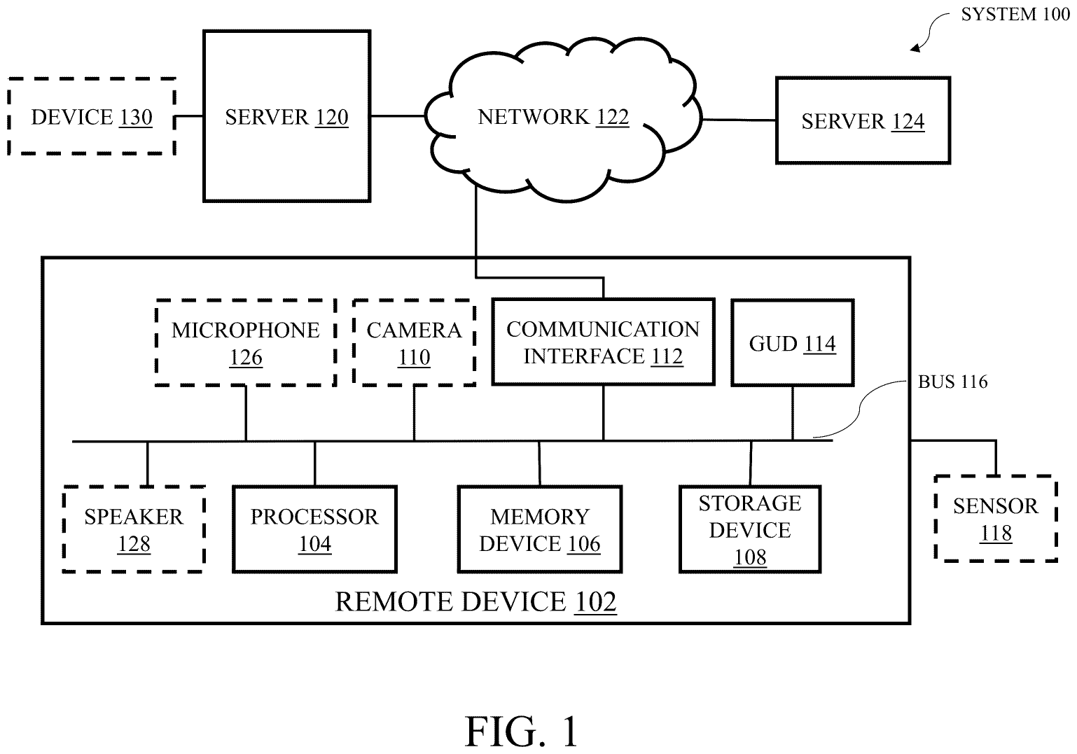

Referring now to the drawings, FIG. 1 illustrates a block diagram of a system 100 configured to implement certain embodiments of the present disclosure. System 100 includes a remote device 102 configured and adapted to generate and/or display information (e.g., a prompt) to a user. Remote device 102 can be a device selected from the group consisting of: a smartphone, a tablet computer, a laptop computer, and a general-purpose computing device. Remote device 102 can be configured to implement a digital assistant, as provided herein.

System 100 also includes a server 120 (and/or connections thereto) and a server 124 (and/or connections thereto). Remote device 102 is illustrated communicably coupled to a server 120 (e.g., a remote server including user information related to one or more users) via network 122 (e.g., an internet connection, a cloud-based connection, a telecommunication tower, a cellular connection, etc.). Remote device 102 and/or server 120 are illustrated communicably coupled to a server 124 (e.g., an external server, a processing server, a cloud-computing server, etc.) via network 122 (e.g., for data computation, request configuration, account verification, etc.). In certain embodiments, system 100 includes another device 130 (e.g., a smartphone, a tablet computer, a laptop computer, a general purpose computing device, a database, and the like).

Device 102 can include a processor 104, a memory device 106, a storage device 108, a communication interface 112, a graphical user display (GUD) 114, and/or a bus 116.

Processor 104 can be any type of processing device (e.g., a central processing unit (CPU), graphical processing unit (GPU), etc.) for carrying out instructions, processing data, and so forth. The processor can implement an operating system such as ANDROID™ or IOS®.

Memory device 106 can be any type of memory device including any one or more of random access memory (RAM), read-only memory (ROM), flash memory, electrically erasable programable read only memory (EEPROM), and so forth.

Storage device 108 can be any data storage device for reading/writing from/to any removable and/or integrated optical, magnetic, and/or optical-magneto storage medium, and the like (e.g., a hard disk, a SSD, a compact disk read-only memory (CD-ROM), CD-ReWritable (CDRW), digital versatile disc-ROM (DVD-ROM), DVD-RW, and so forth). Storage device 108 can also include a controller/interface for connecting to the system bus 116. Thus, memory device 106 and storage device 108 are suitable for storing data as well as instructions for programmed processes for execution of processor 104.

In certain embodiments, device 102 can include a camera 110, a microphone 126, a speaker 128, and/or a sensor 118. Sensor 118 can be an internal sensor (e.g., an integrated accelerometer) and/or an external sensor (e.g., a smart watch, a heartrate monitor, a glucometer, an external blood pressure monitoring device, an IR scanner, etc.). Sensor 118 can be coupled via a wired or wireless link (e.g., a wireless protocol such as BLUETOOTH®).

Camera 110 can be (or include) a high-resolution camera, a high-frame-rate camera, a webcam, a camera integrated into a tablet, a camera integrated into a cell phone, a camera integrated into a personal device, a camera integrated into a computer, or any other device with the capability.

Microphone 126 can be (or include) any device capable of capturing or recording sound in connection with a videotelephony call. Microphone 126 can be integrated directly into device 102 or configured to externally connect (e.g., physically, via wireless transmission, etc.) to device 102 (or any component therein).

GUD 114 can include a touch screen, which can also provide input. Other inputs can include, a keyboard, a keypad, a mouse, a trackpad, or any other type of interface, which can be connected to the system bus 116 (e.g., through a corresponding input/output device interface/adapter).

Communication interface 112 can be adapted and configured to communicate with any type of external device (e.g., server 120, server 124, a remote device, an external sensor, etc.) or with other components of device 102 (e.g., camera 110, microphone 126, GUD 114, etc.). Communication interface 112 can implement various wired or wireless protocols (e.g., WI-FI®, BLUETOOTH®, LTE, DSRC or other suitable communication protocol).

In certain embodiments, device 102 can be configured such that it is discoverable by other devices or systems (e.g., server 120, server 124, device 130, etc.). For example, device 102 can be registered in a database of server 120 and/or server 124 such that it is identified to a particular user. By implementing a permission-based model such that all devices are known, communications between server 120 and/or server 124 and device 102 is more secure (e.g., by preventing unvetted communications) and easy to begin using device 102.

System 100 can be configured to implement a method of reconfiguring a user interface (e.g., receiving, providing, and/or analyzing information in connection with a user). System 100 can establish a telecommunication connection with a user. Information from the telecommunication connection can be transmitted via a connection between remote device 102 and one or more of server 120, network 122, server 124, and/or device 130. A telecommunication connection can include a video channel, an audio channel, and/or a videotelephony connection. A videotelephony connection can utilize a variety of protocols such was WebRTC (available at webrtc.googlesource.com) and/or protocols and/or services provided by OpenTalk of Berlin, Germany; Twillio of San Francisco, California; Vonage of Holmdel, New Jersey; and the like.

System 100 can generate a prompt (e.g., displaying a visual direction for the subject; providing a question to a user via GUD 114 and/or speaker 128; using a chatbot; etc.) to a user of remote device 102. In certain embodiments, the prompt can be automatically provided in response to a detected concern (e.g., a trigger from sensor 118). System 100 can receive data from the user in response to the generated prompt. System 100 can supplement (e.g., augment) the data from the user with information from a user database (e.g., of server 120). The information from the user database can include one or more selected from the group consisting of: age, geographical location, medical conditions, audio-processing conditions, visual-processing conditions, cognitive decline, and personal interests. System 100 can provide the supplemented data to a large language model (LLM) (e.g., of server 124). System 100 can determine a desired response to the provided data based at least in part on the LLM (e.g., of server 124). System 100 can transmit the desired response to the user (e.g., via GUD 114 and/or speaker 128, via a chatbot, etc.).

In certain embodiments, the LLM of server 124 of system 100 can be trained based at least in part on the received data from the user.

In certain embodiments, system 100 can modify a graphical user interface (e.g., of GUD 114) based on one or more of: an audio capability of the user, a visual capability of the user, and/or an audio-visual capability of the user. Such information can be stored in a database of server 120. Such information can be determined by remote device 102 and/or provided by the user, a health care professional, and/or a family member of the user.

In certain embodiments, the method(s) of the disclosure is implemented using a device (e.g., remote device 102) selected from the group consisting of: a smartphone, a tablet computer, a laptop computer, and a general purpose computing device. In certain embodiments, the device includes a graphical user display; and a processor programmed to implement the method(s) of the disclosure. In certain embodiments, the device includes one or more selected from the group consisting of: a communication interface, a microphone, a memory device, and a storage device. In certain embodiments, the graphical user display is configured to display a graphical user interface configured to minimize the input from the user.

In certain embodiments, system 100 includes a device including: a graphical user display; a camera configured to capture a video stream; a processor configured to implement the method(s) of the present disclosure; and/or another device (e.g., device 130) selected from the group consisting of: a smartphone, a tablet computer, a laptop computer, and a general purpose computing device.

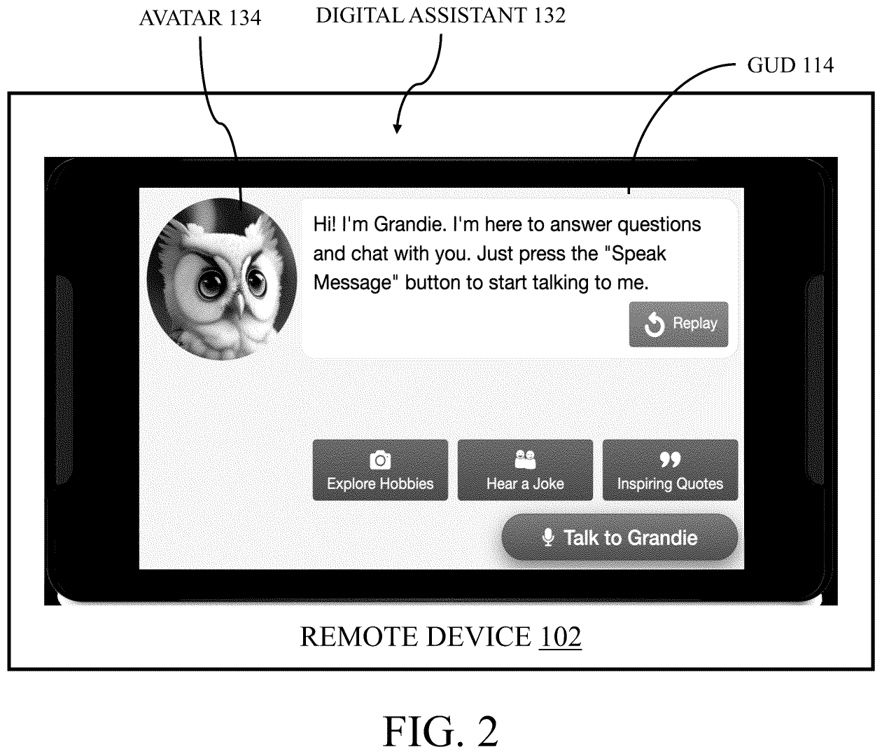

Referring now FIG. 2, a digital assistant 132 is displayed on GUD 114 of remote device 102. In certain embodiments, digital assistant 132 can be used to improve a user experience. Digital assistant 132 can be configured to generate dynamic and/or bespoke prompts for each user. Digital assistant 132 can be augmented by using an avatar 134 configured to interact with the particular user. For example, certain avatars 134 may be preferred by certain demographics or personal information. In FIG. 2, avatar 134 is an owl avatar. Such an avatar 134 can be used in connection with elderly users. Digital assistant 132 and/or avatar 134 can be modified based on the user preferences based on prior (or ongoing) use data. For example, the “personality” of the digital assistant and/or avatar can be modified based on prior interactions. In another example, the appearance, sound, accent, dialect, and/or vocabulary can be modified based on prior interactions. In such an example, digital assistant 132 can be adjusted based on the geographical location of the user (e.g., based on where the remote device is physically located using ISP information and/or GPS; based on the residential history of the user; etc.). The particular accent and/or dialect may be determined using an LLM/AI powered server. Digital assistant 132 can be modified based on medical information of the user (e.g., as provided by a health care professional, as provided by the user, etc.). For example, the volume of digital assistant 132 can be increased for users with hearing impairment. In another example, certain elements on a graphical user interface (GUI) of GUD 114 can be modified if a user has visual impairments (e.g., increasing the size of certain graphics relative to a baseline configuration; increasing the size of the font of text relative to a baseline configuration; implementing a configuration for blind users or users with macular degeneration; etc.) or dexterity impairments (e.g., increasing the size of digital buttons or toggles; simplifying a GUI arrangement; etc.).

In certain embodiments, digital assistant 132 can initiate games. For example, the frequency of the game initiation can be based on user preferences or recommendations from a health care professional (e.g., when a doctor or therapists recommends a user with dementia play certain memory-improvement games).

Digital assistant 132 can be configured to implement a wellness check of the user. The wellness check can be initiated based on the request of another person (e.g., a health care professional, a family member, etc.). The wellness check can be initiated based on an irregular use pattern (e.g., when otherwise consistent behavior of a particular user changes). The wellness check can be initiated when a particular stimulus is detected. For example, the digital assistant can monitor data of an integrated sensor within the remote device and/or an external sensor. In one example, the digital assistant can implement a wellness check when an accelerometer within the remote device exceeds a predefined threshold (e.g., >5 g-force, >10 g-force, etc.), indicating the remote device was dropped. In another example, the digital assistant can implement a wellness check when a microphone detects a particular alert phrase (e.g., “Grandie, help!”) or an irregular sound (e.g., a crashing noise). Digital assistant 132 can implement a wellness check when an external sensor of another device of the user (e.g., a smart watch, a heartrate monitor, a glucometer, etc.) meets or exceeds a predefined alert criteria, such as when: an accelerometer of a smart watch detects a fall; a heartrate monitor detects a heartrate outside of a normal range; and/or when a glucometer detects blood sugar outside of a normal range (e.g., in magnitude and/or time). In certain embodiments, digital assistant 132 can provide automatic health escalations to a caregiver team in view of wellness check information and/or detected information. Digital assistant 132 can be configured to prompt a user with certain questions which can be shared with another (e.g., a health care professional; family; a friend; etc.).

In certain embodiments, digital assistant 132 can be accessed via a chatbot. The chatbot can be integrated with an LLM/AI powered server. The chatbot can be configured to be conversational and parse user inputs prior to connecting with the LLM/AI powered server. The digital assistant and/or chatbot can be used to access certain frequently asked questions (e.g., product-related questions; hours/services of nearby businesses; etc.).

In certain embodiments, digital assistant 132 can be configured to interact with one or more external servers that provides user-specific information. Digital assistant 132 can be configured to receive, provide, or augment transmission information in connection with the one or more external servers. For example, digital assistant 132 can provide user-specific calendar information (e.g., medical appointments) to the user automatically or in response to a user request. In another example, digital assistant 132 can provide user-specific medication information (e.g., reminders to pick up medication from a pharmacy) to the user and/or provider (e.g., health insurance provider, health care professional, etc.). In such an example, digital assistant 132 can improve medication adherence. Certain embodiments of the present disclosure can be used in connection with patient monitoring services (e.g., where a patient is monitored by a physician). For example, a user can be prompted by a remote device (e.g., a personal computing device, a tablet, etc.).

Although certain systems, devices, and methods of the present disclosure are described in connection with FIGS. 1-2, the invention is not so limited.

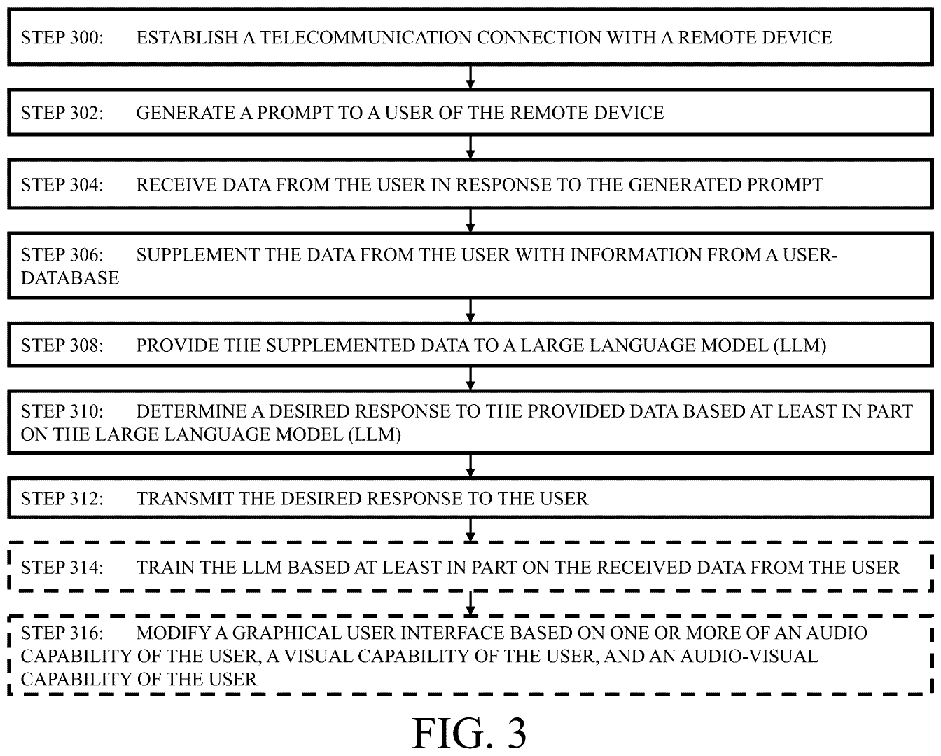

Referring now to FIG. 3, a flow diagram of methods of reconfiguring a user interface (e.g., on an electronic device) is illustrated, in accordance with exemplary embodiments of the present invention. As is understood by those skilled in the art, certain steps included in the flow diagrams may be omitted; certain additional steps may be added; and the order of the steps may be altered from the order illustrated.

At Step 300, a telecommunication connection is established with a remote device (e.g., remote device 102). At Step 302, a prompt can be generated to a user (e.g., an elderly user, a patient with disabilities, etc.) of the remote device. In certain embodiments, the prompt can be a question (e.g., “How are you feeling today?”) or an invitation (e.g., “Would you like to play a game of chess or checkers?”). In certain embodiments, the prompt can be a dialog box through which the user can provide a query (e.g., a chatbot displaying the text “What can I help you with today?”).

At Step 304, data can be received from the user, e.g., in response to the generated prompt.

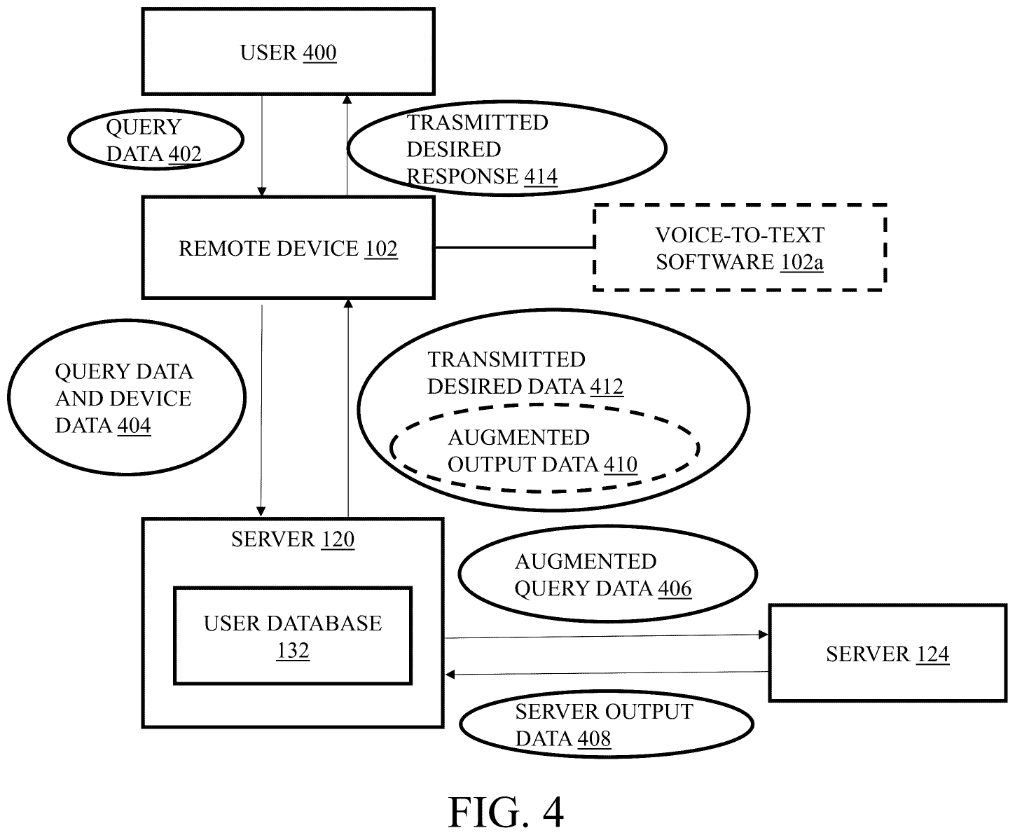

At Step 306, the data from the user can be supplemented with information from a user database (e.g., user database of 132 of FIG. 4). The user database can include information including: age, geographical location, medical conditions, audio-processing conditions, visual-processing conditions, cognitive decline, and/or personal interests. This information from the user database can be combined, supplemented, and/or augmented with the data (e.g., a query) collected from the user. For example, a user with dementia may ask a question which requires an answer with simplified vocabulary. In another example, a user with impaired eyesight and/or hearing may ask a question which requires an answer with a shorter number of words or letters. In one simplified example, a user may ask “what is the weather like today?”; this query may be supplemented with information appended to the query such as: “this individual is 70 years old, lives in Tallahassee, Florida, and has dementia; this individual likes to play golf (e.g., and may be interested in knowing if the weather is nice enough to play golf); provide an answer to the question ‘what is the weather like today?’ in 30 words or less and note if the weather in Tallahassee, Florida is nice enough to play golf”. Accordingly, this supplemented data can be provided to a large language model (LLM), a search engine, and the like.

At Step 308, the supplemented data can be provided to a large language model (LLM). Such a large language model (LLM) can be accessed via or hosted by a server (e.g., server 124). At this step, the supplemented data input (e.g., augmented query data) including specific information about the user (e.g., age, geographical location, medical conditions, audio-processing conditions, visual-processing conditions, cognitive decline, and/or personal interests) can be provided to the LLM. In certain embodiments, healthcare provider information can be provided to the LLM. In such an embodiment, the desired response can be context-rich and can enable additional functions to be carried out. For example, a server (e.g., an LLM server and/or another server) can be configured to offer to call certain health care providers which can provide medical services to the user. Such an offer can be context-rich and reflect known hours of operation for the health care providers and medical specialties relevant to issue presented in the user's question. Accordingly, the expected output from the LLM is tailored to the particular user.

At Step 310, a desired response to the provided data can be determined and based at least in part on the LLM. For example, the desired response may be an answer to a question by the user. The desired response can be based in part on the output data from the LLM. In the specific example above regarding the user from Tallahassee, an answer may not be deemed to be sufficient if the answer returned does not meet specific conditions of the supplemented data (e.g., the augmented data query), such as if the answer is not 30 words or less or if the answer does not note anything about golfing conditions in Tallahassee. If such conditions are not met, the query provided to the LLM can be further modified (e.g., modifying the query to place greater emphasis on the conditions which were not satisfied) and sent back to the LLM.

At Step 312, the desired response can be transmitted to the user. At this step, the user interface (e.g., the GUI/GUD on an electronic device) is reconfigured. For example, the text of the desired response can be displayed. It should be understood that the desired response can be relayed auditorily.

In certain embodiments, additional steps can be included. For example, at optional Step 314, the LLM can be trained based at least in part on the received data from the user. For example, when a user with dementia asks the same question multiple times in a row, the LLM can be trained to provide additional information other than simply answering the question; for example, the LLM can be trained to note (politely) that the user already asked this question today.

In certain embodiments, usage history can be logged. For example, when a user repeatedly calls the same person, the LLM can be trained to advise the user of such history. In certain embodiments, the LLM can be trained to detect changes in speech of the user (e.g., slurred words, unordinary word choice, etc.). In certain embodiments, the LLM can be trained to detect illegal or illogical moves in games. In certain embodiments, the LLM can be trained to detect physical changes in the user (e.g., change in weight as reported, etc.). In certain embodiments, the LLM can be trained to detect changes in daily habits. In any of such embodiments related to usage history, the LLM (or a connected server) can be configured to alert the user, health care professionals, and/or family members of such changes.

Data learned about the user by the platform can be fed to other aspects of the platform to customize for the user. For instance, if the user talks with the platform about bicycles, the Articles app on the GRANDPAD system could automatically start highlighting news and articles regarding cycling. Additionally, data about the user learned by the platform could be stored in a database. This data could be used to further inform the way the platform talks with the user in the future, and could inform future conversation topics.

Learned data can also be used to generate and share “Suggested Prompts” with the user that are based on the user's preferences. For example, the home screen of remote device 102 can suggest cooking and baking related prompts for a user who has expressed interesting in cooking in a previous conversation the LLM.At optional Step 316, a graphical user interface (e.g., of remote device 102, or GUD 114, etc.) can be modified (e.g., based on one or more of an audio capability of the user, a visual capability of the user, and an audio-visual capability of the user). For example, when a user with visual impairment is using a device, the size of text can be enlarged. When a user with audio impairment is using a device, the device can increase the sound volume or switch to a “visual-only” mode. Parameters for such modifications can be stored locally (e.g., on remote device 102) and/or remotely (e.g., on server 120, device 130, and the like).

Referring now to FIG. 4, a block diagram schematic of a method of reconfiguring a user interface is illustrated. A user 400 is illustrated providing query data 402 to remote device 102. This information can be provided by typing the query in (e.g., on GUD 114, a GUI, etc.) and/or by reciting the query orally, which can be deciphered using voice-to-text software 102a. Remote device 102 is illustrated providing the query data and device data 404 (e.g., including IP address, ISP information, device information, time, derivative data from voice-to-text software 102a, etc.) to a server 120. Server 120 can include a user database 132 which includes specific information about the user (e.g., age, geographical location, medical conditions, audio-processing conditions, visual-processing conditions, cognitive decline, and/or personal interests) and/or a plurality of like users. Such information can be included in augmented query data 406 prior to being provided to server 124 (e.g., a server including or communicably coupled with a LLM). Server 124 is illustrated providing server output data 408 (e.g., a desired response, an answer to a query, etc.) to server 120. Server 120 is illustrated providing transmitted desired data 412 to remote device 102. In certain embodiments, the transmitted data 412 can be augmented, as illustrated by augmented output data 410. For example, certain words or phrases may be modified by server 120 (or another server not illustrated) to better suit the needs of the user. In one example, the dialect or accent of the answer (e.g., the server output data 408) may be tailored to the user. In another example, certain words (e.g., expletives) may be filtered out of the answer. In another example, server 120 can implement a safety protocol. For example, the safety protocol can be designed to refrain from providing medical advice. Remote device 102 is illustrated providing a transmitted desired response 414 to user 400. At this step, a user interface of remote device 102 is reconfigured such that the answer is displayed. In certain embodiments, the answer can be transmitted graphically, aurally, or a combination thereof.

Although described in the context of a cloud-based LLM, the invention is not so limited. For example, an LLM can run on the remote device 102 (which is remote relative to the servers 120, 124, but local to the user). Such a local LLM could be used when the remote device 102 is offline (e.g., in the event of a network disruption. The local LLM can also process simpler questions that can be resolved without the need for the cloud-based LLM (e.g., “Grandie, open the Call app.”).

Although the invention is illustrated and described herein with reference to specific embodiments, the invention is not intended to be limited to the details shown. Rather, various modifications may be made in the details within the scope and range of equivalents of the claims and without departing from the invention.

### EQUIVALENTS

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications, and other references cited herein are hereby expressly incorporated herein in their entireties by reference. CLAIMS

1. A method, the method comprising the steps of:
(a) establishing a telecommunication connection with a remote device;
(b) generating a prompt to a user of the remote device;
(c) receiving data from the user in response to the generated prompt;
(d) supplementing the data from the user with information from a user database, the information from the user database including one or more selected from the group consisting of: age, geographical location, medical conditions, audio-processing conditions, visual-processing conditions, cognitive decline, and personal interests;
(e) providing the supplemented data to a large language model (LLM);
(f) determining a desired response to the provided data based at least in part on the large language model (LLM); and
(g) transmitting the desired response to the user.

2. The method of claim 1, further comprising:
(h) training the LLM based at least in part on the received data from the user.

3. The method of claim 1, wherein step (b) includes displaying a visual direction for the subject.

4. The method of claim 1, further comprising:
(i) modifying a graphical user interface based on one or more of an audio capability of the user, a visual capability of the user, and an audio-visual capability of the user.

5. The method of claim 1, wherein the telecommunication connection includes one or more of a video channel and an audio channel.

6. The method of claim 1, wherein the prompt is automatically provided in response to a detected concern.

7. The method of claim 1, wherein steps (b) and (g) include using a chatbot.

8. The method of claim 1, wherein the method is implemented using a device selected from the group consisting of: a smartphone, a tablet computer, a laptop computer, and a general purpose computing device.

9. The method of claim 8, wherein the remote device is selected from the group consisting of: another smartphone, another tablet computer, another laptop computer, and another general purpose computing device.

10. The method of claim 1, wherein the method is implemented using a tablet computer.

11. A device used to implement the method of claim 1, the device comprising:
a graphical user display; and
a processor, the processor programmed to implement the method of claim 1.

12. The device of claim 11, further comprising one or more selected from the group consisting of: a communication interface, a microphone, a memory device, and a storage device.

13. The device of claim 11, wherein the graphical user display is configured to display a graphical user interface, the graphical user interface being configured to minimize the input from the user.

14. A system used in connection with the method of claim 1, the system comprising:
a device including:
a graphical user display;
a camera configured to capture the video stream; and
a processor, the processor configured to implement the method of claim 1; and
another device, the another device being selected from the group consisting of: a smartphone, a tablet computer, a laptop computer, and a general purpose computing device.
